(19) United States
(12) Patent Application Publication
(10) Pub. No.: US 2012/0288606 A1
(43) Pub. Date: Nov. 15, 2012

(54) HIGH PROTEIN COOKED PRODUCT

(76) Inventors: Alan Artner, St. Cloud, MN (US); Jeffery L. Casper, Minneapolis, MN (US); Faith Ford, Big Lake, MN (US); Jonathan Ford, Big Lake, MN (US); Brian Thon, Coon Rapids, MN (US)

(21) Appl. No.: 13/519,215

(22) PCT Filed: Jan. 5, 2011
(86) PCT No.: PCT/US11/20180

§ 371 Date: Jun. 26, 2012

Related U.S. Application Data
(60) Provisional application No. 61/292,562, filed on Jan. 6, 2010.

(51) Int. Cl. A21D 13/00; A21D 10/04

(52) U.S. Cl. 426/553; 426/558; 426/552

(57) ABSTRACT

The present invention relates to chemically leavened batter compositions used for the preparation of cooked food products containing egg protein from pasteurized whole eggs with a PDCAAS score of 1.0, and cooked food products.

### CROSS REFERENCE TO RELATED APPLICATION

This application claims the benefit of the U.S. Provisional Patent Application Ser. No. 61/292,562, filed Jan. 6, 2010, entitled HIGH PROTEIN COOKED PRODUCT, which is hereby incorporated by reference in its entirety.

### BACKGROUND OF THE INVENTION

Commercial food manufacturers strive to deliver improved food products to the consumer to meet a wide variety of consumer preferences. One such consumer preference is the desire to increase the nutritional value of regularly consumed food products such as bakery products. Pancake-type products are popular breakfast items, and have been the subject of formula manipulations and forms to make them more desirable in terms of palatability, convenience, and shelf life stability. These products are ubiquitous in the American diet, particularly with children. This fact makes pancake-type products a desirable vehicle for various nutritional elements.

One such nutritional element is protein. Protein is an essential nutrient for human growth and muscle maintenance, and can be delivered through the addition of many protein containing ingredients. The quality of a protein is assessed by several factors: its essential amino acid composition, digestibility, and bioavailability of amino acids. The protein efficiency ratio (PER), biological value (BV), net protein utilization, and protein digestibility corrected amino acid score (PDCAAS) are the predominant measurement scales and techniques that are commonly utilized to evaluate the quality of protein. The PDCAAS method is accepted by the United Nations and other worldwide organizations as the currently preferred method for measurement of the protein value in human nutrition. As with other aspects of food labeling, the U.S. Food and Drug Administration (FDA) regulates the health claims that can be made by commercial food manufacturers regarding a food product.

### SUMMARY OF THE INVENTION

The present invention is a batter and finished pancake product made there-from. A pancake is a common breakfast food prepared from a batter composition. The batter is poured on a hot flat surface and cooked (or “baked”) on one side, followed by turning or flipping the pancake to cook on the reverse side. The finished pancake has a cake or cream-cake like consistency and a fine, porous structure with a homogenous air cell size distribution. The crumb is generally resilient but moist, demonstrating some degree of elastic response when compressed.

A batter generally is defined as a mixture of flour, water, and other minor ingredients that is thin enough to pour, scoop, spoon, or flow under gravity. Generally speaking, when wheat flour is used in a batter formula, the degree of gluten development is minimized. In the case of pancakes and the like, batters are traditionally cooked on a griddle, resulting in a moist and tender product with a fine but porous cell structure.

The present invention provides a batter composition used for the preparation of bakery food products with a fine crumb, wherein the batter composition comprises by weight:

a. a total water content greater than 40%;
b. egg protein from pasteurized liquid whole eggs present at a concentration of greater than 4.1%, wherein the PDCAAS of the egg protein is 1.0;
c. a sugar content of between 0-12%;
d. an enriched or whole-grain flour content of greater than 25%; and
e. a fat content of between 0-10%.

As is commonly known in the art, air cells are the millions of tiny pockets found inside of a baked good, visible when a piece is cut from it. Known technically as the “crumb,” these air cells are trapped inside the webbing of starch and protein. These air cells are created by one or several actions: 1) the expansion of trapped gases by heat and steam during baking, 2) by one or more leavening agents, such as baking soda, baking powder and yeast, or 3) by mechanical leavening, such as by means of a creaming method and/or egg foaming method. Examples of “fine crumb” specific to baked goods are crumb cake, devil's food cake, or oatmeal cookies. An example of “large crumb” specific to baked goods is angel food cake.

In certain embodiments, the water content is between 40% and 60%, including water contributed through the eggs. The amount of water may be any amount between 45% and 60%, such as 46%, 47%, 48%, 49%, 50%, 55%, 60%, etc. It should be noted that all values given herein are weight percentages.

In certain embodiments, the concentration of the protein in the batter composition is between 11.8% and 100%, or any increment in between. The protein content of liquid whole egg is about 11.8% and the water content is about 65.5%. In certain embodiments, the batter composition lacks milk protein or soy products. In certain embodiments, the batter composition further comprises milk protein. In certain embodiments, the milk protein is nonfat dry milk, low-fat dry milk or whole-fat dry milk, casein, casienate, whey protein concentrate, or whey protein isolate. In certain embodiments, the batter composition further comprises soy flour, soy protein concentrate, or soy protein isolate.

In certain embodiments, the sugar is sucrose, glucose (dextrose), fructose, corn syrup, maltose, invert sugar, and combinations thereof. The amount of sugar may be any amount between 0% and 12% inclusive, such as 0%, 1%, 2%, 3%, 4%, 5%, 10%, 12%, etc.

In certain embodiments, the enriched or whole-grain flour is wheat flour. In certain embodiments, the flour is enriched flour. In certain embodiments, the flour is from non-glutinous starch sources such as rice, tapioca, potato, teff, amaranth, quinoa, oats, corn, millet, buckwheat, and the like. In certain embodiments, the flour is whole grain flour.

In certain embodiments, the batter composition further comprises a chemical leavening agent. In certain embodiments, the chemical leavening agent is baking powder and/or baking soda utilized with a leavening acid, including but not limited to monocalcium phosphate, sodium acid pyrophosphate, sodium aluminum phosphate, dimagnesium phosphate, dicalcium phosphate, calcium acid pyrophosphates, sodium aluminum sulfate, glucono delta lactone, ascorbic acid, lactic acid, citric acid, malic acid, sorbic acid, adipic acid, phosphoric acid.

In certain embodiments, the batter composition further comprises guar gum, gellan, locust bean gum, konjac, gum Arabic, tragacanth, gum karaya, tara gum, propylene glycol alginate, sodium alginate, cellulose gum, methylcellulose, hydroxypropylmmethocellulose, microcrystalline cellulose, gelatin, pullulan, carageenan, and the like. In certain embodiments, the batter composition further comprises colorants, flavorings, fibers, texture modifiers such as hydrocolloids, starches, modified starches, emulsifiers, vitamins, minerals, antimycotics, antimicrobials, and antioxidants.

In certain embodiments, the amount of fat may be any amount between 0% and 10% inclusive, such as 0%, 1%, 2%, 3%, 4%, 5%, 10%, etc.

The present invention provides a cooked food product with a fine crumb comprising:

a. a total water content greater than 20%;
b. egg protein from pasteurized liquid whole eggs present at a concentration of greater than 4.1%, where the PDCAAS of the protein source is 1.0;
c. a sugar content of between 0-15%
d. an enriched or whole-grain flour content of greater than 29%; and
e. a fat content of between 0-12%;
wherein the cooked food product has a Bake Specific Volume (BSV) of 1.5 and 3.0 cc/g.

In certain embodiments, the BSV is 1.7-2.2 cc/g, such as 1.8-2.0 cc/g. The BSV may be any amount between 1.5% and 3.0% inclusive. In certain embodiments, the food product is frozen. In certain embodiments, the shape of the pancake is round. In certain embodiments, the shape of the pancake is that of a slice of bread. In certain embodiments, the pancake has a waffle-like griddle appearance.

In certain embodiments, the water content of the cooked food product is between 20% and 45%. The amount of water may be any amount between 20% and 45%, such as 35%.

In certain embodiments, the concentration of the egg protein of the cooked food product is between 4.2 and 8.0%. In certain embodiments, the food product lacks milk protein or soy products. In certain embodiments, the food product further comprises milk protein. In certain embodiments, the milk protein is nonfat dry milk, low-fat dry milk or whole-fat dry milk, casein, casienate, or whey protein. In certain embodiments, the food product further comprises soy flour, soy protein concentrate, or soy protein isolate.

In certain embodiments, the sugar is sucrose, glucose (dextrose), fructose, corn syrup, maltose, invert sugar, and combinations thereof. The amount of sugar of the cooked food product may be any amount between 0% and 15% inclusive, such as 0%, 1%, 2%, 3%, 4%, 5%, 10%, 15%, etc.

In certain embodiments, the enriched or whole-grain flour is wheat flour. In certain embodiments, the flour is enriched flour. In certain embodiments, the flour is from non-glutinous sources including rice, potato, tapioca, oat, buckwheat, sorghum, quina, teff, and amaranth. In certain embodiments, the flour is whole grain flour. In certain embodiments, the flour content is greater that 22%, such as 25% or 29%.

In certain embodiments, the cooked food product further comprises a chemical leavening agent. In certain embodiments, the chemical leavening agent is baking powder and/or baking soda utilized with a leavening acid, including but not limited to monocalcium phosphate, sodium acid pyrophosphate, sodium aluminum phosphate, dimagnesium phosphate, dicalcium phosphate, calcium acid pyrophosphates, sodium aluminum sulfate, glucono delta lactone, ascorbic acid, lactic acid, citric acid, malic acid, sorbic acid, adipic acid, phosphoric acid.

In certain embodiments, the cooked food product further comprises a hydrocolloid utilized at a low concentration, including but not limited to xanthan, propylene glycol alginate, guar gum, gellan, locust bean gum, konjac, gum Arabic, tragacanth, gum karaya, tara gum, sodium alginate, cellulose gum, methylcellulose, hydroxypropylmmethocellulose, microcrystalline cellulose, gelatin, pullulan, carageenan, and the like. In certain embodiments, the cooked food product further comprises colorants, flavorings, fibers, texture modifiers such as hydrocolloids, starches, modified starches, emulsifiers, vitamins, minerals, antimycotics, antimicrobials, and antioxidants.

In certain embodiments, the amount of fat may be any amount between 0% and 15% inclusive, such as 0%, 1%, 2%, 3%, 4%, 5%, 10%, 15%, etc.

### BRIEF DESCRIPTION OF DRAWINGS

FIG. 1 provides a graph comparing fresh whole eggs and pasteurized whole eggs and their relative viscosity and shear rate.

FIG. 2 shows the comparative Hardness as the amount of egg and sugar are varied. The red or shading indication in the center of the figure is harder, and the blue or shading indication of the outer corners is softer.

FIG. 3 shows the comparative Springiness as the amount of egg and sugar are varied. The red or shading indication at the right side of the figure is springier, and the blue or shading indication of the upper left corner is less springy.

FIG. 4 shows the comparative Cohesiveness as the amount of egg and sugar are varied. The red or shading indication at the right side of the figure is more cohesive, and the blue or shading indication of the left side is less cohesive.

FIG. 5 shows the comparative Gumminess as the amount of egg and sugar are varied. The red or shading indication in the center of the figure is more gummy, and the blue or shading indication of the outer corners is less gummy. Optimal values of gumminess are in the green or shading indication intermediate ring.

FIG. 6 shows the comparative Chewiness as the amount of egg and sugar are varied. The red or shading indication in the center of the figure is more chewy, and the blue or shading indication of the outer corners is less chewy. Optimal values are in the green or shading indication intermediate ring.

FIG. 7 shows the comparative Resilience as the amount of egg and sugar are varied. The red or shading indication at the right side of the figure is more resilient, and the blue or shading indication of the left side is less resilient.

FIG. 8 shows the comparative Product Height as the amount of egg and sugar are varied. The blue or shading indication in the center of the figure has a greater height, and the yellow or shading indication of the outer corners has a lower height. The higher height is most desirable in a pancake-type product.

FIG. 9 shows the comparative Bake Specific Volume (BSV) as the amount of egg and sugar are varied. The blue or shading indication in the center of the figure has a greater BSV, and the yellow or shading indication of the outer corners has a lower BSV. A moderate BSV is most desirable in a pancake-type product.

FIG. 10 shows the comparative Bostwick (i.e., batter viscosity) results as the amount of egg and sugar are varied. The red or shading indication at the lower left side of the figure is indicates more flow of the product, and the blue or shading indication of the upper left corner indicates a more viscous product.

### DETAILED DESCRIPTION OF THE INVENTION

For bakery items such as pancake-type products, many protein sources can be used, however the protein quality of sources from most vegetable sources are limited in essential amino acids and thus have a PDCAAS score lower than 1.0. Another disadvantage of a number of protein sources, such as legumes, meats, nuts, and cereal proteins, is that the organoleptic qualities of the protein are not acceptable (e.g., impart an undesired flavor).

The present invention provides a batter-based food product having a “meat equivalent” or protein content of a 1.0 PDCAAS score. In certain embodiments, 2.5 to 3 ounces (about 70 to 85 grams) of the cooked batter-based product contains enough USDA commodity pasteurized liquid whole egg to meet the criteria as a cooked one-ounce serving, according to the USDA Child Nutrition “one meat” equivalent standard (2.5 oz. of finished product is one meat equivalent per USDA Child Nutrition standards). This present invention is a unique offering in the marketplace, as the egg is incorporated in the batter rather than as a separate and distinguishable component in a multicomponent food product. From a composition standpoint this formulation is novel. While batter products exist that possess a high liquid whole egg content in the range of 20-38% of the total formula, these products also have high sugar content associated with them. Additionally, high egg batters are typically used for egg foam cakes, and the high percentage of sugar in these formulations is often solubilized in the egg prior to a whipping process that incorporates air into a stable egg and sugar foam prior to the incorporation of flour. Unlike these standard formulations and processes, the high protein batter system for commercial application according to the invention has a lower sugar content than egg foam cakes, a higher egg content than standard pancake formulas where the egg is not whipped into a foam, and is chemically leavened unlike crepes or many egg foam cakes, and lastly results in a pancake like appearance, texture, and flavor. Additionally, the product provides the equivalent of 1 oz of cooked egg, having a PDCAAS of 1.0, per 2.5 to 3 oz serving.

As a comparison, foam cakes are examples of traditional batter products that are produced using high egg and high sugar content. Foam cakes fall under a category of product known to the French as Biscuit (pronounced “bis-kwee”) and typically are comprised of whole eggs, egg yolks, egg whites, and sugar, which provide the structure for products such as sponge cake, angel food cake, genoise, and chiffon cake. These cakes typically contain little fat and are often prepared from separated eggs, allowing for the whipping of the egg whites separately from the yolks and then reincorporated with the addition of flour. Angel Food cakes are a type of foam cake that uses only the egg white, while geniose will require whole eggs and sugar being heated to 110° F. over a double boiler prior to whipping. For all egg foam cakes, the dry ingredients are folded in carefully after the foam has been prepared.

A standard genoise formula has approximately 40-45% egg, 20-25% sugar, and 15-20% flour.

Typical Genoise Formula*

| Ingredient | % |
|---|---|
| Whole Eggs | 45.9% |
| Granulated sugar | 23.0% |
| Cake Flour | 16.9% |
| Cornstarch | 6.1% |
| Butter | 7.7% |
| Vanilla Extract | 0.4% |
| Total % | 100 |

*From The Professional Chef, Culinary Institute of America, 2002 edition, John Wiley & Sons, New York.

A standard Jelly Roll Sponge Cake formula has approximately 30% egg, 25-30% sugar, and 25-30% flour.

Typical Jelly Roll Sponge Cake Formula*

| Ingredient | % |
|---|---|
| Sugar | 26.7% |
| Whole eggs | 24.1% |
| Egg yolks | 5.3% |
| Salt | 0.6% |
| Corn Syrup | 3.7% |
| Water | 2.5% |
| Vanilla | 0.3% |
| Hot Water | 9.7% |
| Cake Flour | 26.7% |
| Baking Powder | 0.4% |
| Total | 100.0% |

*From Professional Baking, second edition, by Wayne Gisslen. John Wiley & Sons, Inc. 1994

In contrast to the egg foam cake formulations, typical American Pancake recipes are typically low in egg and sugar as compared to egg-foam based cakes, and contain a greater amount of flour. These products are prepared using the “muffin method,” where the dry ingredients are mixed just until moistened. American pancake products are almost always chemically leavened, except in the case of crepes, which are unleavened and have a denser texture.

American Style Pancakes*

| Ingredient | % |
|---|---|
| Pastry Flour | 55.3% |
| Sugar | 7.4% |
| Salt | 0.6% |
| Baking Powder | 3.7% |
| Whole Eggs | 5.4% |
| Milk | 24.6% |
| Oil | 3.1% |
| Total | 100% |

*From Professional Baking, second edition, by Wayne Gisslen. John Wiley & Sons, Inc. 1994

In U.S. Pat. No. 4,353,932 (“Refrigerator pourable and stable pancake batters for preparing stable pancakes and method for preparing”), a pancake formula that is describes as “a standard and accepted pancake batter recipe” is presented. The flavor, texture, and strength of the pancakes were deemed good. In this formula, the egg content was 13.3% and the sugar content was 6.6%, an example of a low sugar, low egg formulation. The formula is provided below:

“Standard and accepted” pancake batter recipe*

| Ingredient | % |
|---|---|
| Whole fresh egg | 13.3% |
| Buttermilk solids | 3.1% |
| Milk | 50.3% |
| Wheat Flour | 25.8% |
| Baking powder | 0.9% |
| Sucrose | 6.3% |
| Salt | 0.3% |
| Total | 100% |

A standard crêpe recipe is provided below, which has a low sugar content, but also has a low protein content.

Crêpes*

| Ingredient | % |
|---|---|
| Bread Flour | 11.9% |
| Cake Flour | 11.9% |
| Sugar | 2.9% |
| Salt | 0.7% |
| Eggs | 17.9% |
| Milk | 47.6% |
| Butter Oil | 7.1% |
| Total | 100% |

*From Professional Baking, second edition, by Wayne Gisslen. John Wiley & Sons, Inc. 1994

Similarly to the crepe, US Patent Application Publication 0107779A1 provides a description of a pancake batter called a “pancrepe” that has a high egg content. The purpose of the “pancrepe” invention is to provide for a pancake that has greater flexibility and can be folded without cracking. Even though this batter is described as “high egg,” patent publication discusses a batter with an egg protein content of 1.6 wt % to about 4.0 wt %, and specifically exemplifies a batter containing 2.26 wt % egg protein (i.e., a liquid whole egg usage level of 18%).

A standard waffle recipe is provided below, which has a low sugar content, but also has a low protein content.

Waffle batter*

| Ingredient | % |
|---|---|
| Pastry Flour | 30.1% |
| Salt | 0.3% |
| Baking Powder | 2.0% |
| Egg Yolks | 7.4% |
| Milk | 45.2% |
| Oil | 15.1% |
| Egg Whites | 11.4% |
| Sugar | 4.0% |
| Total | 100% |

*From Professional Baking, second edition, by Wayne Gisslen. John Wiley & Sons, Inc. 1994

Thus, a number of well-known foods have high protein content, but also have a high sugar content (e.g., genoise, jelly roll sponge cake), or have a low sugar content, but also have a low protein content (e.g., pancakes, crêpes and waffles).

In the pancake batter of the subject invention the whole egg content is dramatically increased to levels well above that of standard pancakes, while maintaining sugar levels typical of a pancake formulation. In certain embodiments, the egg included in these batters is at levels between 25 and 50 percent, the range being dramatically higher than that of standard and accepted pancake and waffle formulations. The pancake batter formulation does not require whipping of the eggs into a stable foam prior to baking as does typical egg foam based formulations, because the product relies on chemical leavening for expansion. The source of eggs does influence viscosity. The pancake batter formulation of the invention is prepared using pasteurized whole egg. The use of pasteurized whole egg imparts surprising viscosity-enhancing properties. This is surprising because the viscosity of the fresh egg is greater that the viscosity of a pasteurized whole egg, which would lead one to believe that its use would increase viscosity of the batter instead of decreasing viscosity.

This surprising and unexpected discovery that using a less viscous pasteurized egg to produce a more viscous batter is helpful in producing a batter based product with improved volume and texture, particularly when the batter contains sugars levels that are lower than typical sponge cakes or egg foam based cakes that utilize high sugar content to help increase viscosity. As shown in Example 2, as sugar levels increase, the apparent viscosity, or consistency, of the batter increases as demonstrated by lower numbers, which represent fewer centimeters of flow achieved in 30 seconds. This increase in sugar content in order to increase batter viscosity, however, has undesirable health effects.

Another attribute of the present invention is that the batter has a low sugar content of less than 12%, such as between 0-12% by weight. The finished, cooked product has a sugar content of less than 15%.

The lower sugar content of the invention also has the added benefit in production in that it does not result in sticking to the baking surface as do formulations containing sugar levels common to those in the cake type batter products. The sugar content of the present invention is within ranges common to standard pancake formulations, specifically levels that are less than 15% and more specifically less than 10% of the final batter formulation. In contrast, even the highest egg foam cakes will have greater than 20% sugar or sugar replacement ingredients. These replacement ingredients are saccharides, more specifically any mono or disaccharide, sugar alcohol, maltodextrin, or fibers such as polydextrose, inulin, or corn syrup fiber. This sugar range differentiates the high egg batter of the present invention from egg foam cakes.

Another attribute of the present invention is that the batter has a low fat content of less than 15%, such as between 0-10% by weight. The finished, cooked product has a fat content of less than 12%.

Other ingredients that can be included in the batter will be leavening agents, colorants, flavorings, fibers, texture modifiers such as hydrocolloids, starches, modified starches, emulsifiers, vitamins, minerals, antimycotics, antimicrobials, and antioxidants.

The invention will now be illustrated by the following non-limiting Examples.

### Example 1

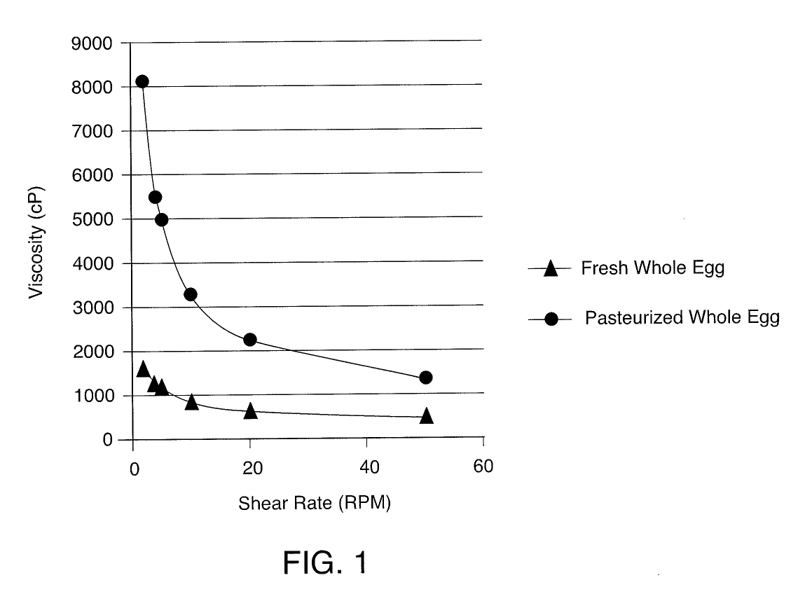

The following premix formulation was prepared using a Hobart model N-50 mixer equipped with a paddle attachment. The sugars and shortening were creamed and the mixture subsequently blended with the remaining dry ingredients. The premix blend was first mixed with fresh whole egg and water according to the recipe below. A second batter was mixed using the premix, pasteurized whole liquid egg and water. The batter viscosities were measured using a Brookfield DV-II+ viscometer outfitted with a #6 spindle (FIG. 1). Results surprisingly showed that the higher viscosity fresh whole egg resulted in lower viscosity across the breadth of shear rates, while the lower viscosity pasteurized whole egg resulted in higher viscosity batter. The higher viscosity is advantageous for the high moisture batter as it helps retain leavening gas and promotes expansion during baking.

| | |
|---|---|
| Ingredient | % |

Stage 1: Creaming

| | |
|---|---|
| Sugar | 17.34% |
| Dextrose | 2.71% |
| Shortening; Clear Valley Icing (No | |
| Trans) | 7.59% |

Stage 2: Premix Make Up

| | |
|---|---|
| Wheat Flour; Cargill H&R All Purpose | 66.44% |
| Salt | 1.63% |
| B&V flavor | 0.60% |
| Propylene Glycol Alginate | 0.10% |
| Baking soda | 1.73% |
| AMCP | 0.33% |
| SALP | 1.47% |
| Total | 1.00 |

| Batter make-up | % | g |
|---|---|---|
| Premix | 38.5 | 500.5 |
| Water | 25.14 | 326.82 |
| Egg | 36.36 | 472.68 |

### Example 2

The formula used in Example 1 was used in a response surface design where egg and sugar content was evaluated on the attributes of resulting pancakes. A central composite design was used to determine the effects of sugar content ranging between 10 and 40%, and pasteurized liquid egg between 15 and 45%. The water content of the batters was maintained by adjusting for the moisture differences in the amount of pasteurized liquid whole egg.

Experimental Design for Example 2.

| | Randomized Run | | |
|---|---|---|---|
| Standard Run Order | Order | % Egg | % Sugar |
| 2 | 1 | 45 | 10 |
| 10 | 2 | 30 | 25 |
| 4 | 3 | 45 | 40 |
| 3 | 4 | 15 | 40 |
| 8 | 5 | 30 | 46.2 |
| 6 | 7 | 51.2 | 25 |
| 7 | 8 | 30 | 3.8 |
| 5 | 9 | 8.8 | 25 |
| 1 | 10 | 15 | 10 |
| Standard Run Order | Randomized Run | % Egg | % Sugar |
| | Order | | |

After mixing, batter consistency was measured using a Bostwick consitometer. 50 g of batter was then deposited into round forms of about 3½ to 4 inches (about 9 to 10 cm) inches in diameter. Product was baked for 4 minutes in an Airforce IMP 4509 JR steam injected hot air impingement oven (Heat and Control Inc, Hayward, Calif.) set at 192° C. After baking, product was allowed to cool and was blast frozen.

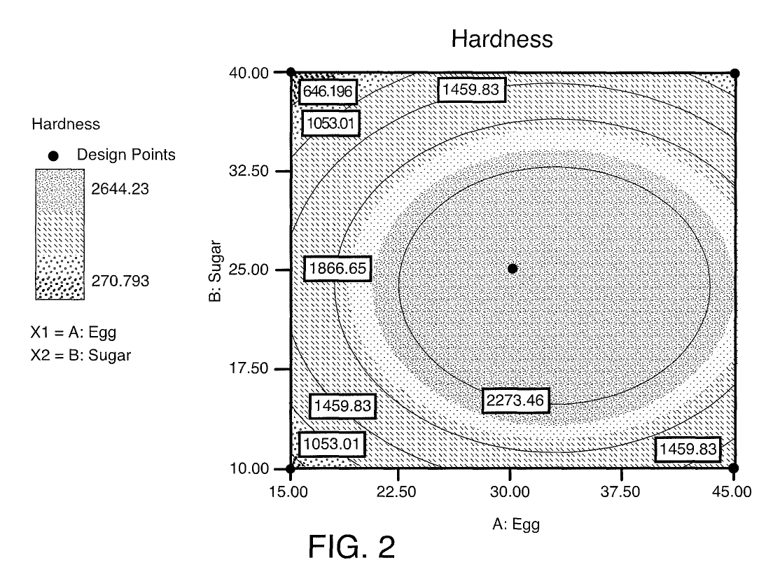

After freezing, product was allowed to thaw and equilibrate to ambient temperatures. Product heights were measured and TPA analysis was performed using a TaXT2 texture analyzer. TPA measurements were collected in triplicate. Baked specific volume measurements were also measured using a TexVol B990 bread volume measurement device. All data was analyzed using Stat-Ease Design Expert 7 software (Stat-Ease Inc, Minneapolis, Minn.). From the data, response surface plots were created (FIG. 2-10). The various characteristics that were measured were Hardness, Springiness, Cohesiveness, Gumminess, Chewiness, Resilience, Product Height, Bake Specific Volume (BSV), and Bostwick (i.e., batter viscosity). The characteristics above allow for a general description of the product texture in objective terms. These results can be used to compare the present invention with standard products

Hardness is a measurement of the peak force of the first compression of the product, in this case compression to 50% the original height of the product. The response surface plot for this measurement is provided in FIG. 2.

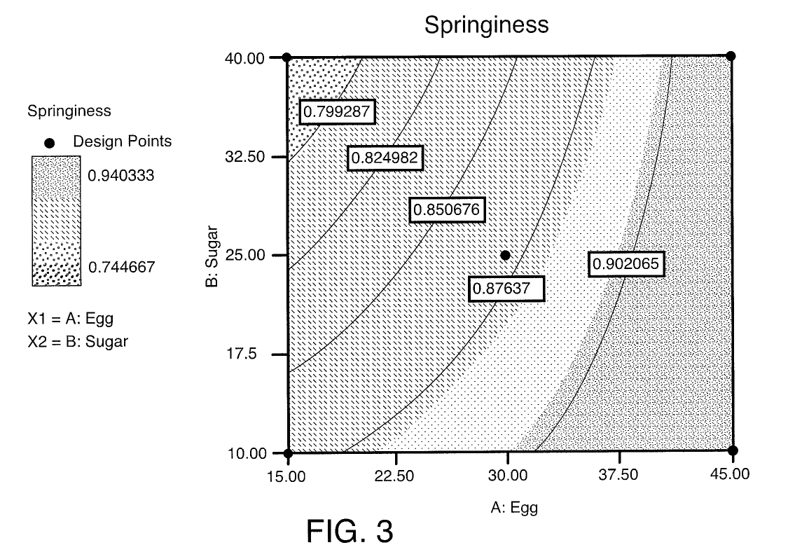

Springiness is a measurement of how well a product recovers to its original height or position after deformation during the first compression. The height at the second compression is the determination of this recovery or “springiness.” The response surface plot for this data is provided in FIG. 3.

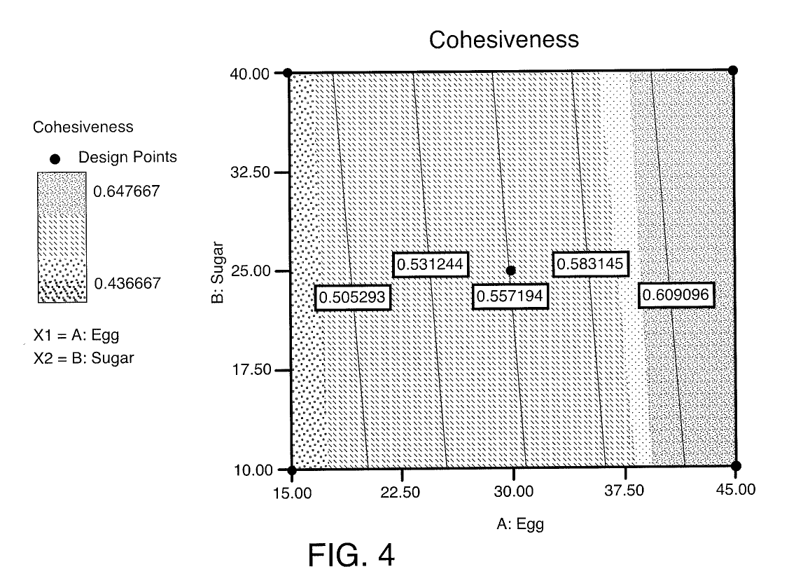

Cohesiveness is defined as how the product behaves during a second deformation relative to how it behaved through the first deformation. It is calculated as work during the second compression divided by work during the first compression. The response surface plot is provided in FIG. 4.

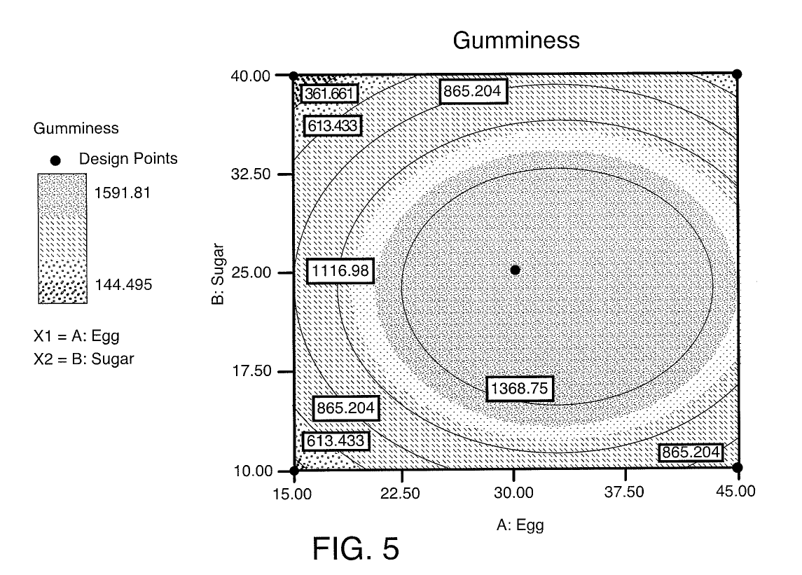

Gumminess is a measurement calculated as Hardness *Cohesiveness, and related to how rubber-like a product is. For example a hard product that is very cohesive would have a high gumminess value. The surface plot is provided in FIG. 5.

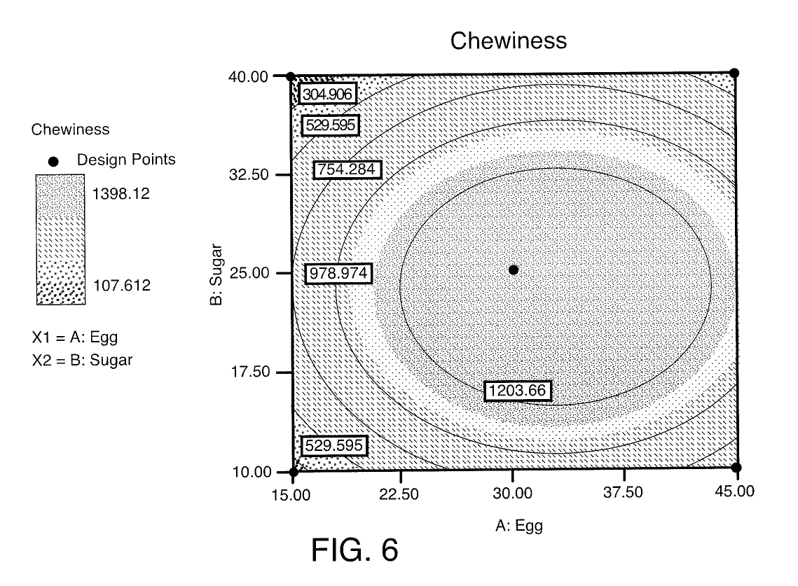

Chewiness is calculated as Gumminess*Springiness and the surface plot is provided in FIG. 6.

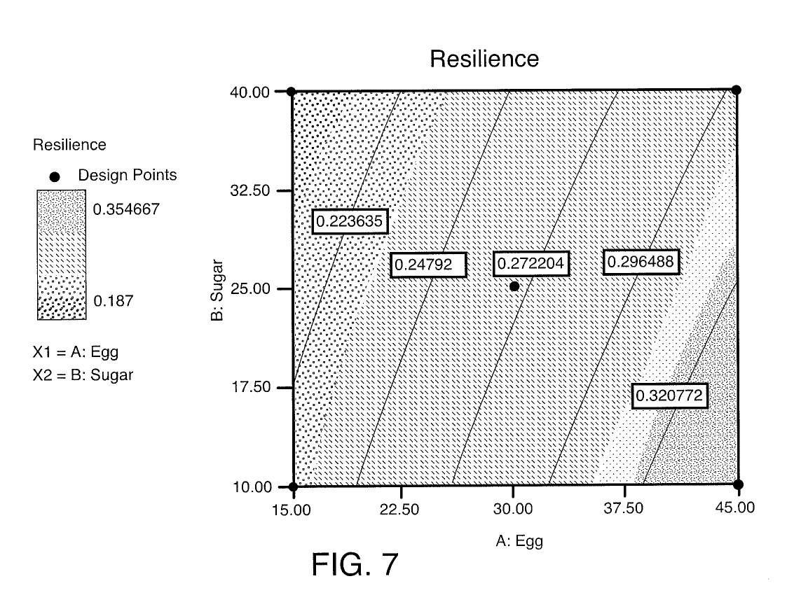

Resilience is a measurement similar to that of Springiness, but is a measurement of how well a material instantly resists deformation. The response surface plot for this measurement is provided in FIG. 7.

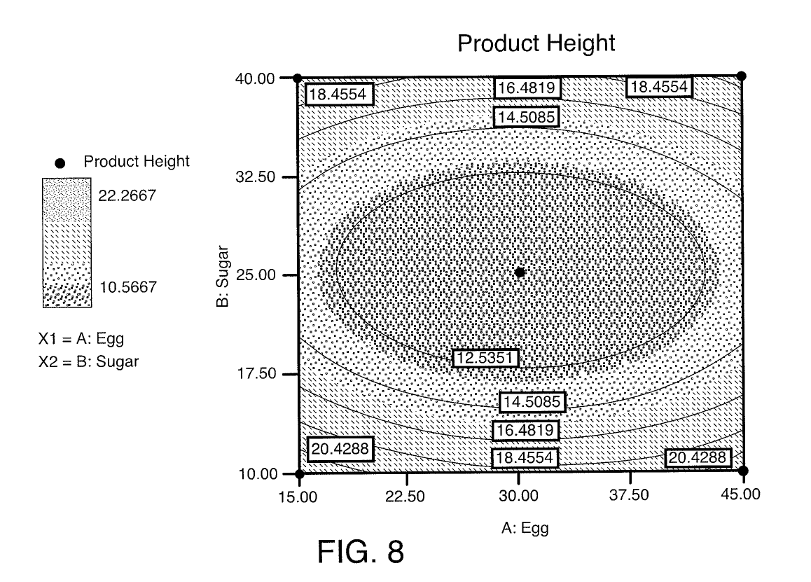

Product Height is a measurement of the thickness of the product. The surface plot is provided in FIG. 8.

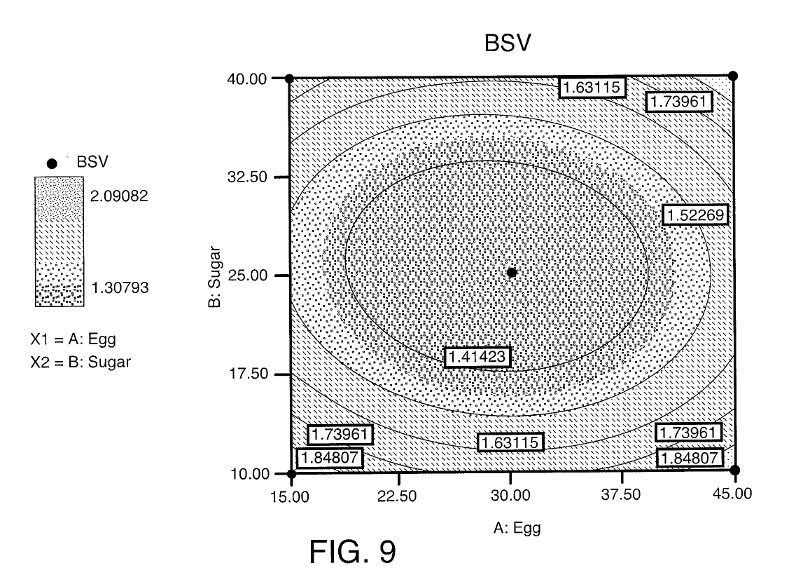

Bake Specific Volume (BSV) is the inverse of density, so it is a measurement of unit volume per unit mass. Baked specific volume is generally reported in units of cubic centimeters per gram (cc/g). The response surface plot for this measurement is provided in FIG. 9.

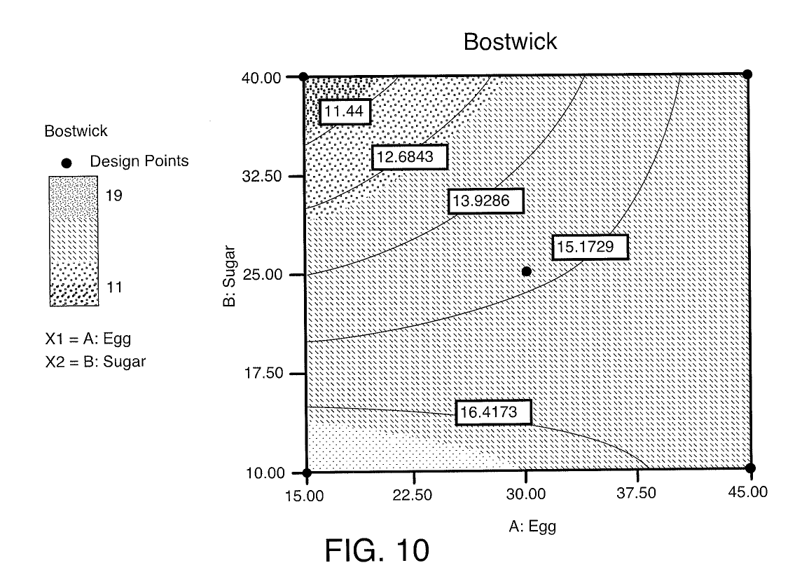

The Bostwick consitometer is a simple test where a material's consistency is determined by measuring the distance a material will flow under its own weight for a specific period of time; thus the higher the apparent viscosity, the smaller the flow distance. The results are reported in centimeters, and the response surface plot is provided in FIG. 10.

Results from the experimental design demonstrate that a pancake batter with egg content between 15% and 35%, and sugar content between 20 and 40% results in a short, dense/low BSV product with negative textural attributes (hard, gummy, chewy, less resilient). By reducing the sugar to 10%, all of these attributes are improved. At 10% sugar, the resilience and the springiness of the product was greatly improved with increasing egg, which also correlated with the decreased values observed in the Bostwick consitometer.

Although the foregoing specification and examples fully disclose and enable the present invention, they are not intended to limit the scope of the invention, which is defined by the claims appended hereto.

All publications, patents and patent applications are incorporated herein by reference. While in the foregoing specification this invention has been described in relation to certain embodiments thereof, and many details have been set forth for purposes of illustration, it will be apparent to those skilled in the art that the invention is susceptible to additional embodiments and that certain of the details described herein may be varied considerably without departing from the basic principles of the invention.

The use of the terms “a” and “an” and “the” and similar referents in the context of describing the invention are to be construed to cover both the singular and the plural, unless otherwise indicated herein or clearly contradicted by context. The terms “comprising,” “having,” “including,” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Embodiments of this invention are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A batter composition used for the preparation of bakery food products with a fine crumb, wherein the batter composition by weight comprises:
a. a total water content greater than 40%;
b. egg protein from pasteurized liquid whole eggs present at a concentration of greater than 4.1%, wherein the protein digested corrected amino acid score (PDCAAS) of the egg protein is 1.0;
c. a sugar content of between 0-12%;
d. an enriched or whole-grain flour content of greater than 25%; and
e. a fat content of between 0-10%.

2. The batter composition of claim 1, wherein the flour is wheat flour.

3. The batter composition of claim 2, where the flour is from non-glutinous cereal grains.

4. The batter composition of claim 1, further comprising a chemical leavening agent.

5. The batter composition of claim 1, further comprising guar gum, gellan, locust bean gum, konjac, gum Arabic, tragacanth, gum karaya, tam gum, propylene glycol alginate, sodium alginate, cellulose gum, methylcellulose, hydroxypropylmmethocellulose, microcrystalline cellulose, gelatin, pullulan, and/or carageenan.

6. The batter composition of claim 1, wherein the batter composition lacks milk or soy protein.

7. (canceled)

8. A cooked food product comprising:
a. a total water content greater than 35%;
b. egg protein from pasteurized whole eggs present at a concentration of greater than 4.1%, where the protein digested corrected amino acid score (PDCAAS) of the egg protein is 1.0;
c. a sugar content of between 0-15%;
d. an enriched or whole-grain flour content of greater than 22%; and
e. a fat content of between 0-15%;
wherein the cooked food product has a Bake Specific Volume (BSV) of 1.5 to 3.0 cc/g.

9. The cooked food product of claim 8, wherein the BSV is 1.7-2.2 cc/g.

10. The cooked food product of claim 8, wherein the food product is frozen.

11. The cooked food product of claim 8, wherein the flour is wheat flour.

12. The cooked food product of claim 8, where the flour is from non-glutinous cereal grains.

13. The cooked food product of claim 8, further comprising a chemical leavening agent.

14. The cooked food product of claim 8, further comprising guar gum, gellan, locust bean gum, konjac, gum Arabic, tragacanth, gum karaya, tara gum, propylene glycol alginate, sodium alginate, cellulose gum, methylcellulose, hydroxypropylmmethocellulose, microcrystalline cellulose, gelatin, pullulan, and/or carageenan.

15. The cooked food product of claim 8, wherein the batter composition lacks milk or soy protein.

16. A cooked food product consisting of:
a. a total water content greater than 35%;
b. egg protein from pasteurized whole eggs present at a concentration of greater than 4.1%, where the protein digested corrected amino acid score (PDCAAS) of the egg protein is 1.0;
c. a sugar content of between 0-15%;
d. an enriched or whole-grain flour content of greater than 22%; and
e. a fat content of between 0-15%;
wherein the cooked food product has a Bake Specific Volume (BSV) of 1.5 to 3.0 cc/g.
